(19) United States
(12) Patent Application Publication
(10) Pub. No.: US 2010/0098889 A1
(43) Pub. Date: Apr. 22, 2010

(54) HEAT-SHRINKABLE SLEEVE FOR USE ON TOOLING DURING THE PROCESS OF MANUFACTURING COMPOSITE PARTS

(75) Inventors: Joseph A. WILLIAMS, IV, Auburn, OH (US); Mike LESTER, Burton, OH (US); Michael WILLIAMS, Landrum, SC (US)

Correspondence Address: PEARNE & GORDON LLP, 1801 EAST 9TH STREET, SUITE 1200, CLEVELAND, OH, 44114-3108, US

(73) Assignee: DUNSTONE COMPANY, INC., Hiram, OH (US)

(21) Appl. No.: 12/582,484

(22) Filed: Oct. 20, 2009

Related U.S. Application Data
(60) Provisional application No. 61/106,673, filed on Oct. 20, 2008.

(51) Int. Cl. F16B 4/00; B32B 37/26; B32B 7/10

(52) U.S. Cl. 428/34.9; 156/84

(57) ABSTRACT

A heat-shrinkable sleeve (3) made of a self-releasing material and having a linear seam is disclosed along with methods of employing a heat-shrinkable sleeve (3) in a process of manufacturing composite parts, either as a release layer between the composite part (9) and tool (7), or on a composite material to provide a consolidation force to the composite part (9).

### PRIORITY

This application claims the benefit of U.S. Provisional Application No. 60/106,673 filed Oct. 20, 2008.

### BACKGROUND OF THE INVENTION

1. Field of the Invention

The present invention relates to the manufacturing of composite parts, particularly; to the use of a heat-shrinkable sleeve during the manufacturing of composite parts as a release layer on tooling, or to provide a compression force on the composite part.

2. Description of Related Art

Prior art methods for molding a composite structure around a tool, such as a mandrel, have required tape wrapping or painting the mandrel with a release coating. The tape and/or paint layer protects the composite part from sticking to the mandrel. Similarly, the prior art teaches tape wrapping the composite after molding to provide a consolidation force to the composite. However, such taping and painting methods are time consuming and expensive. Further, such processes are not easily controlled.

Applicants have determined that one way to avoid tape wrapping and painting a mandrel, or tape wrapping a molded composite, is to employ a heat-shrinkable sleeve having self-releasing properties. Continuously molded heat-shrinkable sleeves are known for other applications in the prior art, however the material for such sleeves is expensive and the processes to produce them are time consuming and expensive. Furthermore, such sleeves would generally require a release coating.

To overcome deficiencies in the prior art, applicants have invented a novel heat-shrinkable sleeve and method for using the same during the manufacturing process of composite parts.

### SUMMARY OF THE INVENTION

In a first aspect there is provided an apparatus comprising a heat-shrinkable sleeve. The heat shrinkable-sleeve has an inner surface and an outer surface and a linear seam. The sleeve contracts along a diameter of the sleeve upon application of heat to the sleeve, and the sleeve comprises at least one material selected from ETFE, ECTFE, FEP, PFA, MFA, PVDF, PVF, PTFE, Nylon, BOPP, or PMP. The heat shrinkable sleeve can comprise multiple layers of heat-shrinkable material and can shrink in a machine direction or grow in a machine direction.

In another aspect there is provided a method of manufacturing a composite part. The method comprises placing a heat-shrinkable sleeve over a tool prior to placement of material to be formed into the composite part on the heat-shrinkable sleeve.

In an even further aspect there is provided a method of manufacturing a composite part. The method comprises placing a heat-shrinkable sleeve over a material to be formed into a composite part and applying heat to the heat-shrinkable sleeve to cause the heat-shrinkable sleeve to shrink to fit the composite part. In one embodiment, the heat-shrinkable sleeve applies a consolidating force to the composite part during curing, and in another embodiment the heat-shrinkable sleeve is used as a release layer.

In the foregoing methods, the heat-shrinkable sleeve has an inner surface and an outer surface and a linear seam. The sleeve comprises at least one heat-shrinkable material, and the sleeve contracts along a diameter of the sleeve upon application of heat to the sleeve. The heat-shrinkable sleeve can comprise multiple layers of heat-shrinkable material. The inner and/or the outer surface can be self-releasing or have a release coating. Further, the heat-shrinkable sleeve can either grow or shrink in a machine direction.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a partial perspective view of the assembly of the heat-shrinkable sleeve of the current invention.

FIG. 2 is an exploded view of the heat-shrinkable sleeve of the current invention employed on a tool.

FIG. 3 is an exploded view of the heat-shrinkable sleeve placed on a tool prior to placement of material that forms a composite part.

FIG. 4 is a partial perspective view of the heat-shrinkable sleeve employed on a tool.

FIG. 5 is an exploded view of an example heat-shrinkable sleeve having an optional release coating on its inner surface, an optional release coating on its outer surface, and an optional release film on a composite part.

FIG. 6A is perspective view of the heat-shrinkable sleeve being released from a composite part.

FIG. 6B is a perspective view of the heat-shrinkable sleeve being released from a tool.

FIG. 7A is a perspective view of a heat-shrinkable sleeve being peeled from a composite part.

FIG. 7A is a perspective view of a heat-shrinkable sleeve being peeled from a tool.

FIG. 8A is a cross sectional view of a heat-shrinkable sleeve peeling away from a composite part due to shrinking.

FIG. 8B is a perspective view of a heat-shrinkable sleeve tearing away from a composite part or tool due to shrinking.

### DETAILED DESCRIPTION OF THE INVENTION

An example embodiment of a device that incorporates aspects of the present invention is shown in the drawings. It is to be appreciated that the shown example is not intended to be a limitation on the present invention. For example, one or more aspects of the present invention can be utilized in other embodiments and even other types of devices.

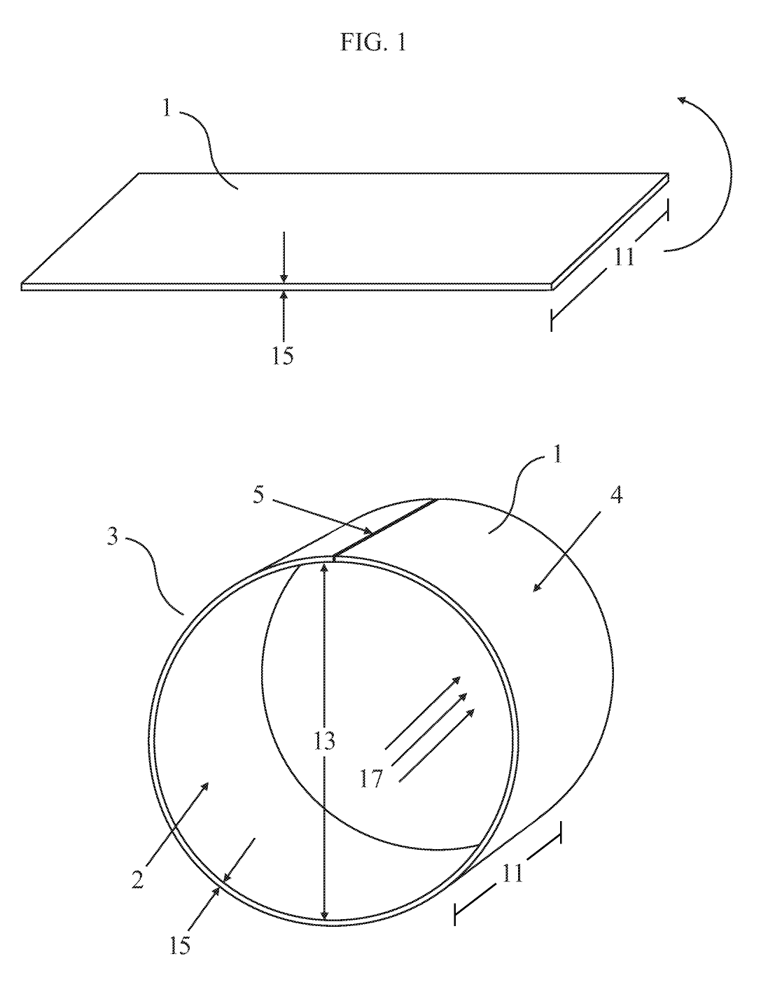

A heat-shrinkable sleeve 3 is provided as shown in FIG. 1. The heat-shrinkable sleeve 3 is made from a sheet of heat-shrinkable material 1. The sheet of heat-shrinkable material 1 is wound in a tubular fashion so that one end of the sheet of material can be connected by a linear overlap seam 5 to the other end of the sheet of material to create a heat-shrinkable sleeve 3. In one embodiment, the heat shrinkable sleeve is in the form of a tube. Though the heat-shrinkable sleeve 3 may be in the form of a perfectly cylindrical tube, the heat-shrinkable sleeve 3 also may be of imperfect tubular shape. The heat-shrinkable sleeve may also be of any other shape so long as the heat-shrinkable sleeve 3 has at least one opening and is hollow, having an inner surface 2 and an outer surface 4 defined by the sleeve material, and a linear overlap seam 5 running substantially in a machine direction 17 along the sleeve. It is to be appreciated that the machine direction 17 of the sleeve material will run the length of the sleeve. The linear overlap seam 5 can be produced, for example, by using a solvent weld, if the material is PETG, or similar, adhesive weld, thermal weld, ultrasonic weld, laser weld or tape seam among other things. The linear seam heat-shrinkable sleeve 3 can be produced in rolls of standard length 11, diameter 13 and wall thickness 15 and the end user may cut the sleeve to a desired length. Alternatively, the sleeve also may be produced in discreet lengths or diameter as ordered by an end user. Further, an end user may specify the thickness of the sheet of material from which the sleeve is made at any area of the material such that the sleeve wall can be of uniform thickness or of varying thickness along its length and circumference. It is to be appreciated that, regardless of the shape of the heat-shrinkable sleeve, the term diameter refers to the straight line distance between opposing surfaces of the sleeve.

The heat-shrinkable sleeve 3 can be constructed of a material that can shrink in the transverse direction, shrink slightly or not at all in the machine direction, or grow in the machine direction. Some heat-shrinkable materials for the heat-shrinkable sleeve 3 can be polyester, or polyester-glycol films such as PETG. A further list of materials useful in the present invention includes other heat-shrinkable materials, such as, for example, PEEK, PEI, PSU, PPSU, PPS, polyimides and the like. The material may also be a multi-layer sheet of heat-shrinkable materials.

In some embodiments, the heat-shrinkable material 1 also exhibits self-releasing characteristics. The terms release and self-releasing as used herein are intended to refer to a sleeve that does not adhere to, or allows for ease of removal of the sleeve from material with which the sleeve comes into contact. Thus, a self-releasing sleeve can be made of a material that does not adhere to, or is easily released from, material with which the sleeve will be brought into contact, without requiring any additional release material. Such materials can be, for example, ETFE, ECTFE, FEP, PFA, MFA, PVDF, PVF, PTFE, Nylon, BOPP, PMP or multi-layer sheets using a combination of the foregoing materials, such as ETFE-Nylon-ETFE or FEP-PTFE, for example.

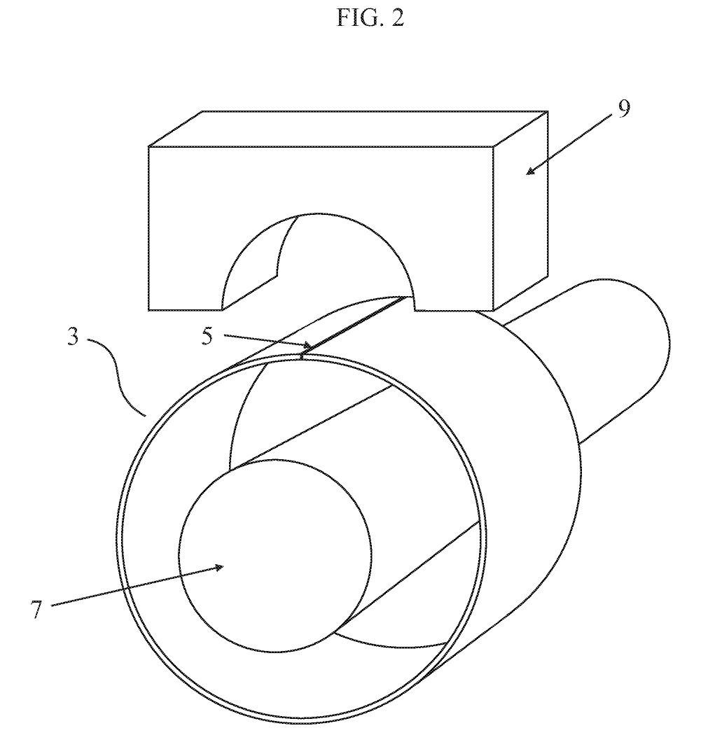

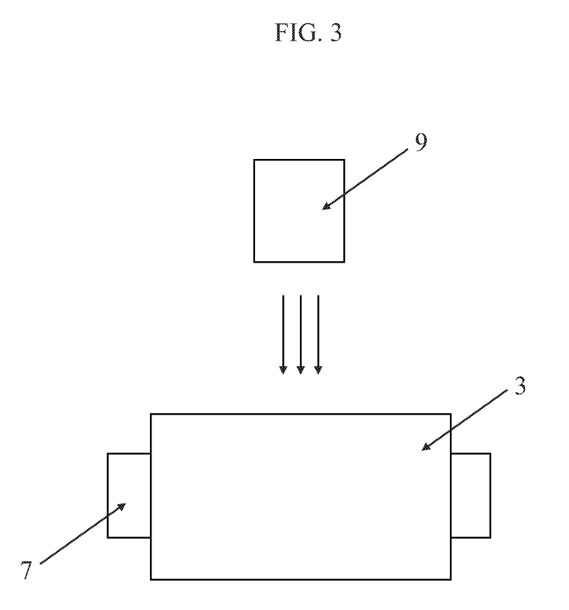

A heat-shrinkable sleeve 3 having a linear overlap seam 5, as discussed herein, can be used in the manufacture of composite parts, among other things. As depicted in FIG. 2, the heat-shrinkable sleeve 3 may be employed on a tool 7, such as, for example, a wash-out or knock-out mandrel produced from plaster or similar material, a metal tool, a thermoset composite tool, a rubber tool, an inflatable tool or similar, or the heat-shrinkable sleeve 3 may also be employed with the material that forms the composite part 9. As depicted in FIG. 3, the heat-shrinkable sleeve 3 can be inserted on to the tool 7 followed by placement of the material for the composite part 9 on to the heat-shrinkable sleeve 3. In either event, it is to be appreciated that the heat-shrinkable sleeve 3 can provide a release layer between the tool 7 and the material of the composite part 9. A composite part 9 is laid-up over the heat-shrinkable sleeve 3 using, for example, wet laid, filament wound, pre-preg, or vacuum infusion technology. Some type of consolidating force may then be used on the outside of the composite part 9, such as an autoclave, vacuum bag, press fixture, female mold or tool, heat-shrinkable tape or tape wrapping.

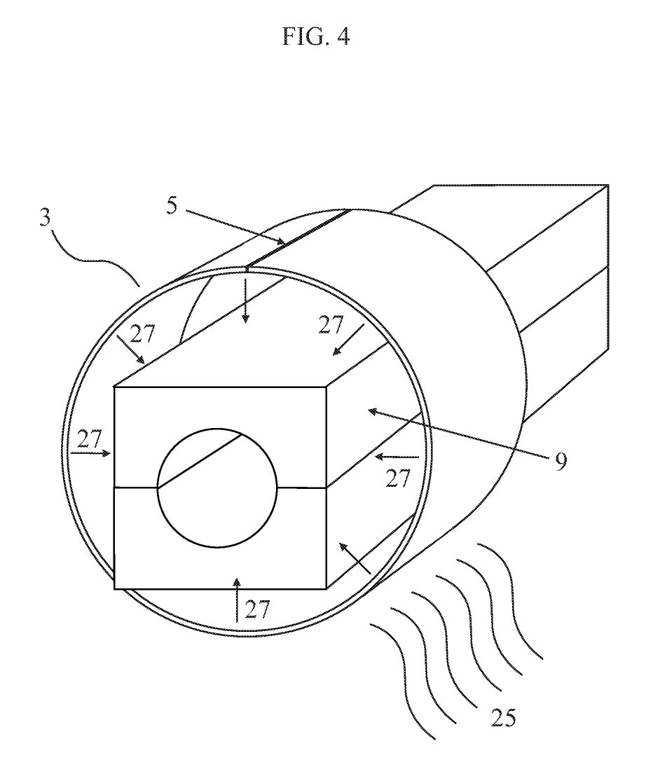

The heat-shrinkable sleeve 3 may also be used as a release layer on the outside of a composite part 9, such as shown in FIG. 4. To utilize the heat-shrinkable sleeve 3 in such a manner, the heat-shrinkable sleeve 3 can be placed over the material to be used to form the composite part 9, such as a pre-preg or wet wind material for example. Here again, some type of consolidating force may then be used on the outside of the composite part 9, such as an autoclave, vacuum bag, press fixture, female mold or tool, heat-shrinkable tape or tape wrapping.

In addition the heat-shrinkable sleeve 3 as described herein also can be used to provide a consolidating force to a composite part 9 during the manufacturing process. The heat-shrinkable sleeve 3 may be placed over a prior placed release layer on the composite part 9, or the heat-shrinkable sleeve 3 may be placed directly over the material to be used to form the composite part 9. When heat 25 is applied to the heat-shrinkable sleeve 3 during the curing process, the sleeve material will shrink in the transverse direction causing the sleeve to contract in its diameter 27. Contraction in the sleeve diameter can cause the sleeve to apply a consolidating force to the outside of the composite part 9 while the composite part is curing, helping consolidation of the composite.

The rate and amount of shrinkage in the transverse direction of the sleeve material can be controlled to ensure the precise amount of contraction in the sleeve's diameter, ensuring the desired consolidating force is applied to the composite part 9. Likewise, the growth or shrinkage in the machine direction along the sleeve can also be controlled according to the needs of the process. As one of ordinary skill in the art will appreciate, control of shrinkage can be based on the orientation of the sleeve material and its base properties, which include, but are not limited to, the machine direction shrinkage, transverse direction shrinkage, shrink force, sleeve material thickness, number of layers of sleeving employed, and the temperature and time of heat application, for example. A sleeve that can shrink in the machine direction could be useful for curved parts, as would a sleeve that could grow in a machine direction. Among other things, growth or shrinkage in the machine direction would help eliminate any potential wrinkles in the shrink sleeve on the inside or outside surfaces of the part.

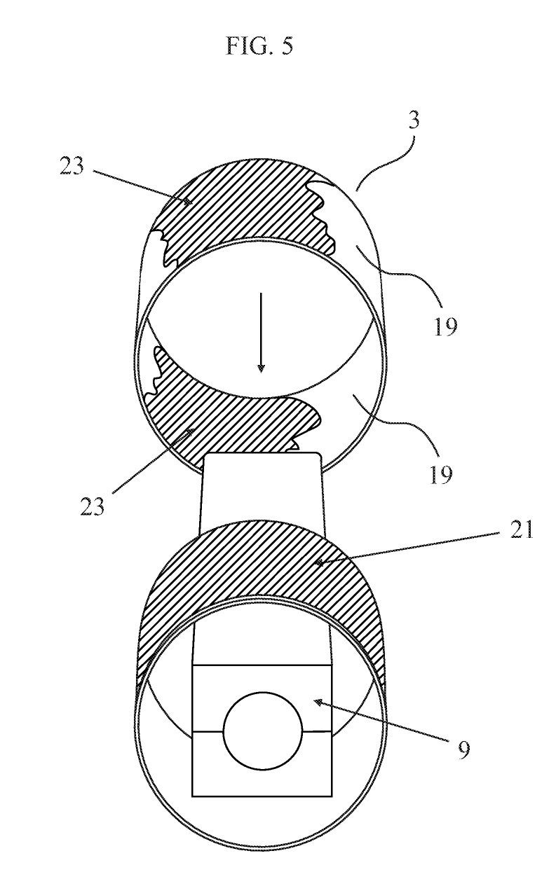

Although it is preferred that the material of the heat-shrinkable sleeve 3 is self-releasing, the material may have a release coating 23 on a contact surface 19 as shown in example FIG. 5. A release coating 23 can be any material added to the surface of the heat-shrinkable sleeve 3 that supports or provides release. The release coating 23 may be applied to the entire contact surface 19 or a portion thereof. The contact surface 19 is the surface of the sleeve making contact with either the tool 7 or material to be formed into the composite. Where a release coating 23 is applied, it can be applied at any point in time, whether prior to forming the sleeve or subsequent to its formation. In one example embodiment, a release coating 23 can be applied as part of a continuous forming process in which, for example, sleeve material is unrolled from a spool, release coating material 23 is optionally applied to the material, the material is formed into a generally tubular shape, a seam is welded and the product is then rolled onto a spool. Alternatively, a release film or paint 21 may be applied to the tool 7 or composite part 9 to provide or improve release characteristics.

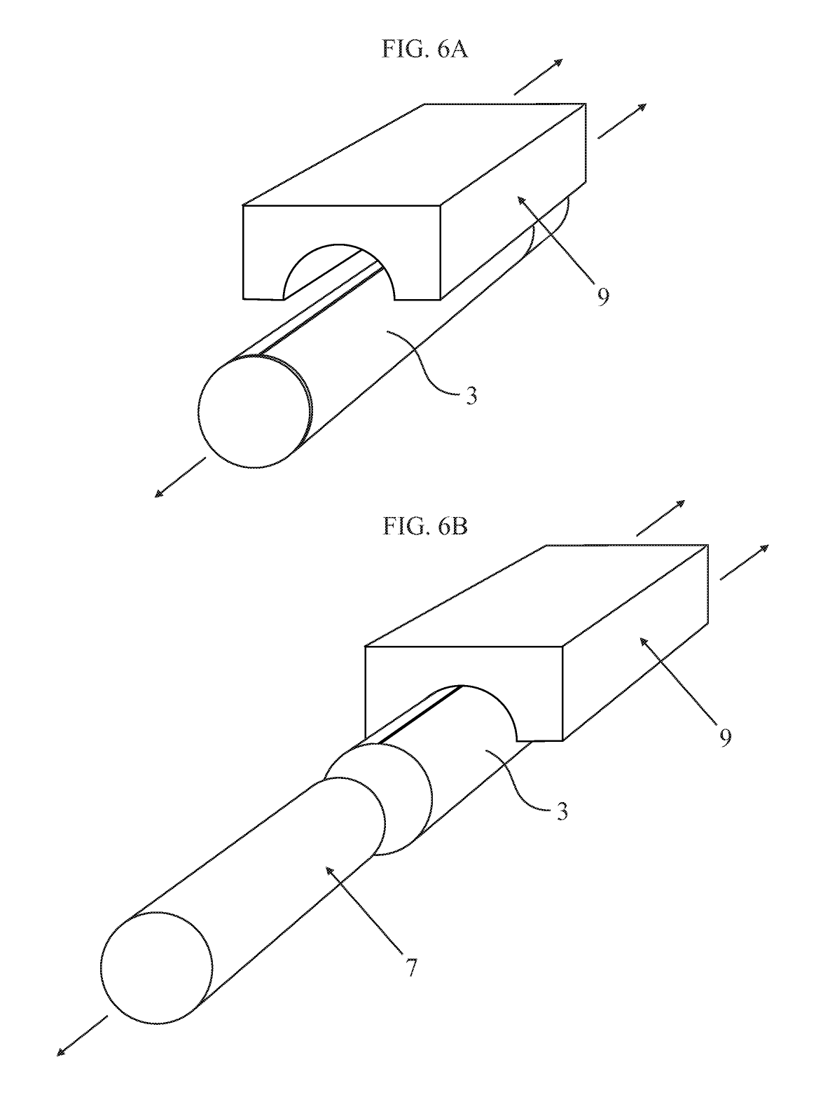

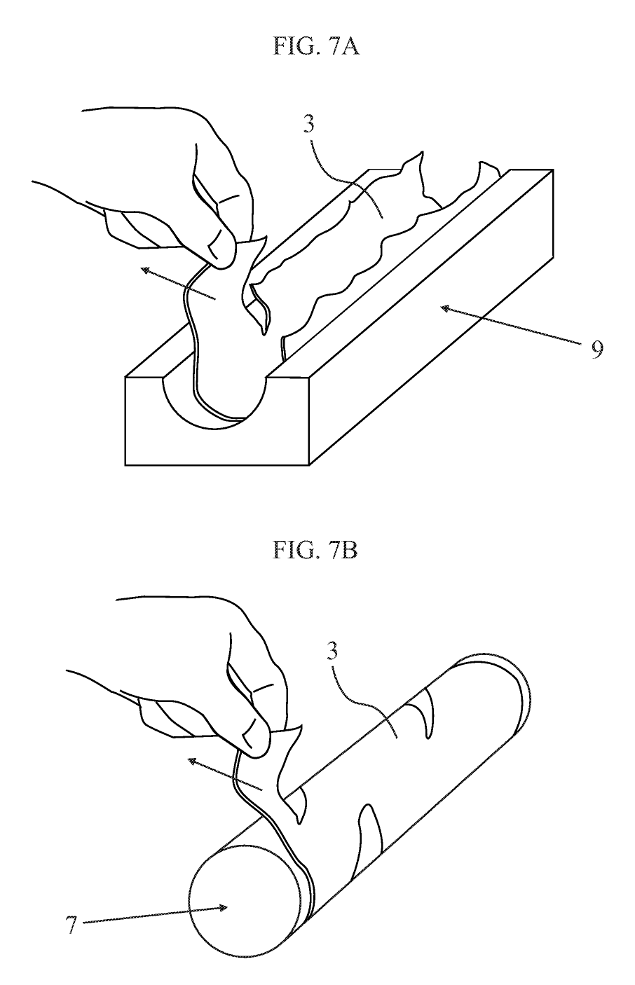

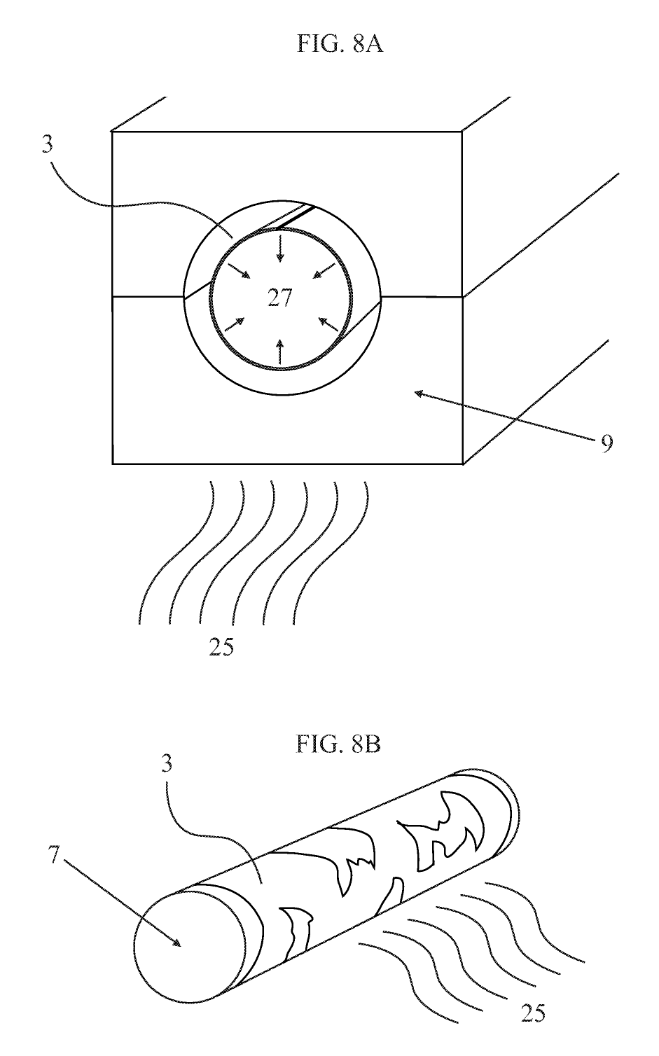

After employing the heat-shrinkable sleeve 3 in a process of manufacturing a composite part 9 as described herein, the heat-shrinkable sleeve 3 can be removed from the composite part 9 as depicted in FIGS. 6-8. The heat-shrinkable sleeve 3 can be removed from the composite part 9 and tool 7, for example, by slipping the heat-shrinkable sleeve 3 off the composite part 9 or tool 7 as shown in FIGS. 6A and 6B respectively, by peeling the heat-shrinkable sleeve 3 off of the composite part 9 or tool 7 as shown in FIGS. 7A and 7B respectively, or by applying heat 25 to the composite part 9 causing the heat-shrinkable sleeve 3 to shrink further, thereby allowing the heat-shrinkable sleeve 3 to peel itself off of the composite part 9 or tool 7 as shown in FIGS. 8A and 8B. Alternatively, and according to the needs of the particular process, the heat-shrinkable sleeve 3 may not possess any release characteristics. In such an instance, the heat-shrinkable sleeve 3 may be peeled or removed in some other manner from the composite part 9 or tool 7. In addition, the heat-shrinkable sleeve 3 may be designed to remain on the composite part 9 or tool 7.

The invention has been described with reference to various example embodiments. Obviously, modifications and alterations will occur to others upon a reading and understanding of this specification. It is intended to include all such modifications and alterations insofar as they come within the scope of the appended claims or the equivalents thereof.

What is claimed is:

1. An apparatus comprising a heat-shrinkable sleeve having an inner surface and an outer surface and a linear seam, wherein the sleeve contracts along a diameter of the sleeve upon application of heat to the sleeve, wherein the sleeve comprises at least one material selected from ETFE, ECTFE, FEP, PFA, MFA, PVDF, PVF, PTFE, Nylon, BOPP, or PMP.

2. The apparatus of claim 1, wherein the heat-shrinkable sleeve is comprised of multiple layers of heat-shrinkable material.

3. The apparatus of claim 2, wherein the selected material forms at least one of the inner surface and the outer surface.

4. The apparatus of claim 2, wherein the selected material forms both the inner and outer surfaces.

5. The apparatus of claim 1, wherein the inner surface is coated with a release coating.

6. The apparatus of claim 1, wherein the outer surface is coated with a release coating.

7. The apparatus of claim 1, wherein the sleeve material shrinks in a machine direction.

8. The apparatus of claim 1, wherein the sleeve material grows in a machine direction.

9. A method of manufacturing a composite part, the method comprising, placing a heat-shrinkable sleeve over a tool prior to placement of material to be formed into the composite part on the heat-shrinkable sleeve, said heat-shrinkable sleeve having an inner surface and an outer surface and a linear seam, wherein the sleeve comprises at least one heat-shrinkable material, and wherein the sleeve contracts along a diameter of the sleeve upon application of heat to the sleeve.

10. The method of manufacturing a composite part according to claim 9, wherein the heat-shrinkable sleeve is comprised of multiple layers of heat-shrinkable material.

11. The method of manufacturing a composite part according to claim 10, wherein at least one of the inner surface and the outer surface are self-releasing.

12. The method of manufacturing a composite part according to claim 10, wherein both of the inner surface and the outer surface are self-releasing.

13. The method of manufacturing a composite part according to claim 9, wherein the inner surface of the sleeve is coated with a release coating.

14. The method of manufacturing a composite part according to claim 9, wherein the outer surface of the sleeve is coated with a release coating.

15. The apparatus of claim 9, wherein the sleeve material shrinks in a machine direction.

16. The apparatus of claim 9, wherein the sleeve material grows in a machine direction.

17. A method of manufacturing a composite part, the method comprising, placing a heat-shrinkable sleeve over a material to be formed into a composite part and applying heat to the heat-shrinkable sleeve to cause the heat-shrinkable sleeve to shrink to fit the composite part, said heat-shrinkable sleeve having an inner surface and an outer surface and a linear seam, wherein the sleeve comprises at least one heat-shrinkable material, and wherein the sleeve contracts along a diameter of the sleeve upon application of heat to the sleeve.

18. The method of manufacturing a composite part according to claim 17, wherein the heat-shrinkable sleeve is used to apply a consolidating force to the composite part.

19. The method of manufacturing a composite part according to claim 18, wherein a release film is applied to the composite part prior to placement of the heat-shrinkable sleeve.

20. The method of manufacturing a composite part according to claim 18, wherein the heat-shrinkable sleeve is comprised of multiple layers of heat-shrinkable material.

21. The method of manufacturing a composite part according to claim 20, wherein the inner surface of the heat-shrinkable sleeve is self-releasing.

22. The method of manufacturing a composite part according to claim 20, wherein the inner surface of the sleeve is coated with a release coating.

23. The method of manufacturing a composite part according to claim 17, wherein the heat-shrinkable sleeve is used as a release layer.

24. The method of manufacturing a composite part according to claim 23, wherein the heat-shrinkable sleeve is comprised of multiple layers of heat-shrinkable material.

25. The method of manufacturing a composite part according to claim 24, wherein at least one of the inner surface and the outer surface of the heat-shrinkable sleeve is self-releasing.

26. The method of manufacturing a composite part according to claim 24, wherein both the inner surface and the outer surface of the heat-shrinkable sleeve are self-releasing.

27. The method of manufacturing a composite part according to claim 23, wherein the inner surface of the sleeve is coated with a release coating.

28. The method of manufacturing a composite part according to claim 23, wherein the outer surface of the sleeve is coated with a release coating.

29. The method of manufacturing a composite part according to claim 23, wherein a consolidating force is applied to the composite part after placement of the heat-shrinkable sleeve.

30. The apparatus of claim 17, wherein the sleeve material shrinks in a machine direction.

31. The apparatus of claim 17, wherein the sleeve material grows in a machine direction.
